(19) United States
(12) Patent Application Publication
(10) Pub. No.: US 2026/0050414 A1
(43) Pub. Date: Feb. 19, 2026

(54) NATURAL COSMIC EVENT AS SOURCE OF RANDOM NUMBER

(71) Applicant: Wells Fargo Bank, N.A., San Francisco, CA (US)

(72) Inventors: Peter Burton Bordow, Fountain Hills, AZ (US); Rameshchandra Bhaskar Ketharaju, Hyderabad (IN); Bradford A. Shea, Mint Hill, NC (US)

(21) Appl. No.: 18/808,862

(22) Filed: Aug. 19, 2024

(51) Int. Cl. G06F 7/58; H04L 9/08

(52) U.S. Cl. CPC G06F 7/588; H04L 9/0863

(57) ABSTRACT

Systems and techniques may generally be used for controlling a low earth orbit (LEO) satellite. An example technique may include sending a control signal to a thruster of the LEO to maintain a trajectory of the LEO satellite along a particular orbit, and capturing, at a sensor device, at least one photon. The example technique may include generating, for example using processing circuitry at the LEO satellite, a random number based on the at least one photon.

### BACKGROUND

Satellites may be in any of various orbits, such as a low earth orbit (LEO), which includes orbits that are at or below 2,000 kilometers above the Earth's surface (with some having a higher apogee), a medium earth orbit (MEO), which includes orbits above 2,000 kilometers up to around geosynchronous orbit (e.g., around 35,000 to 36,000 kilometers). An example type of satellite in MEO includes global positioning system (GPS) satellites, which orbit the Earth twice per day. Geosynchronous satellites may remain stationary with respect to a location on Earth because they rotate at the same rate as the Earth. Above geosynchronous orbit is high earth orbit (HEO), which has very few human made satellites.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a satellite in accordance with some examples.

FIG. 2 illustrates a diagram showing a satellite configured to generate a random number based on environmental data in accordance with some examples.

FIG. 3 illustrates a block diagram showing a satellite configured to generate a random number based on space debris in accordance with some examples.

FIG. 4 illustrates example circuitry in a node in accordance with some examples.

FIG. 5 illustrates a flowchart showing a technique for controlling a low earth orbit (LEO) satellite in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein provide a random number based on an environmental or light condition, such as via a photon received at a satellite. A satellite may be a low earth orbit (LEO) satellite, such as one configured to maintain an orbit, such as via a thruster. The satellite may include cryptographic circuitry, for example to generate a password, a key, a one time pad, etc. from a random number.

The LEO satellite may use any of a variety of techniques for generating a random number. The “randomness” of a random number has increasingly become an issue as computing devices become faster, and other technologies, such as quantum computing, are maturing. Traditional cryptographic techniques may not be able to provide sufficient randomness to keep information secure as the quantum computing and other technologies further develop. In order to obtain more “randomness” in generated random numbers, the systems and techniques described herein use a complex input based on identifiable environmental phenomena that are extremely difficult to replicate (e.g., challenging to recreate a particular vantage point, a particular time, etc.) that result in robust random numbers, while at the same time not being excessively difficult to generate.

The systems and techniques described herein broadly fall under two categories, first a capture of a photon originating at the sun or other star, and second, an image based on photons in an image captured of space or the earth from a LEO satellite. The first category includes capturing a gamma ray, directly from the sun or reflected by the atmosphere of earth (e.g., as solar irradiance), or detecting solar radiation. The second category includes using an image captured of orbital debris as a source for entropy.

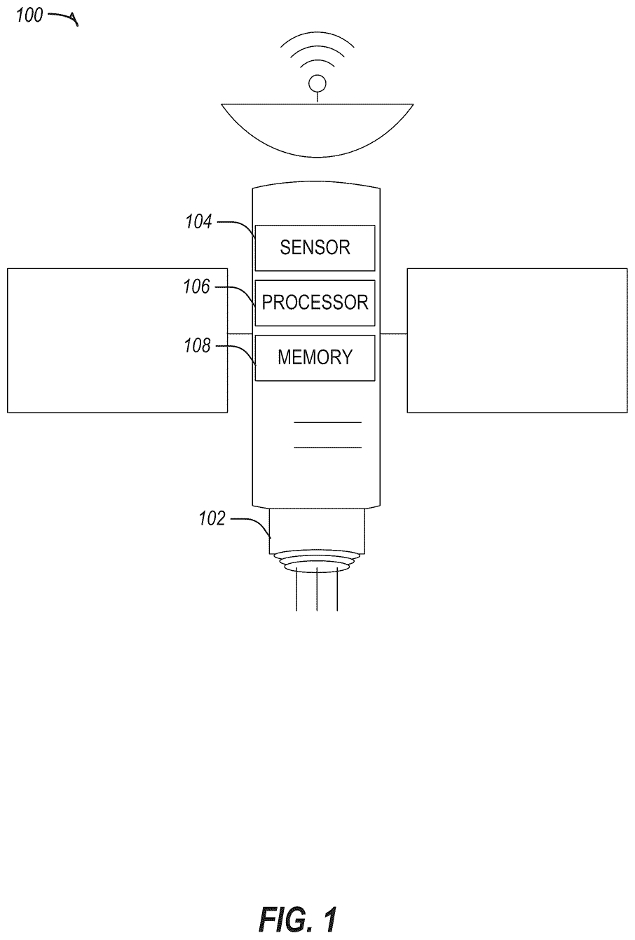

FIG. 1 illustrates a satellite 100 in accordance with some examples. The satellite 100 includes a thruster 102, a sensor 104, processing circuitry (e.g., a processor 106), memory 108, etc. (e.g., may include communication circuitry, a quantum random number generator, etc.). The thruster 102 may be used to maintain a trajectory (e.g., orbit) of the satellite 100 (e.g., in a LEO) or to change a trajectory (e.g., to raise up or down in the LEO range, to return to earth or connect with another satellite or device, or to move to a different orbit, such as MEO). The sensor 104 may include a camera, a pyranometer, a gamma ray detector, an electromagnetic field detector, or the like. The processor 106 and the memory 108 may be used to execute and store, respectively, instructions for implementing the systems and techniques described herein. For example, the processor 106 may generate a one time pad, password, or a key pair, such as based on a random number generated using the sensor 104. In some examples, a Monte Carlo simulation may be performed using a stream of random numbers generated by information captured by the sensor 104. In another example, stream of random numbers generated by information captured by the sensor 104 may be used with a Markov chain. The Monte Carlo simulation or the Markov chain may be used to make a prediction, such as a likely next transaction of a customer, a likely next communication need for the satellite 100, a type of cryptography to use for a next transaction, or the like.

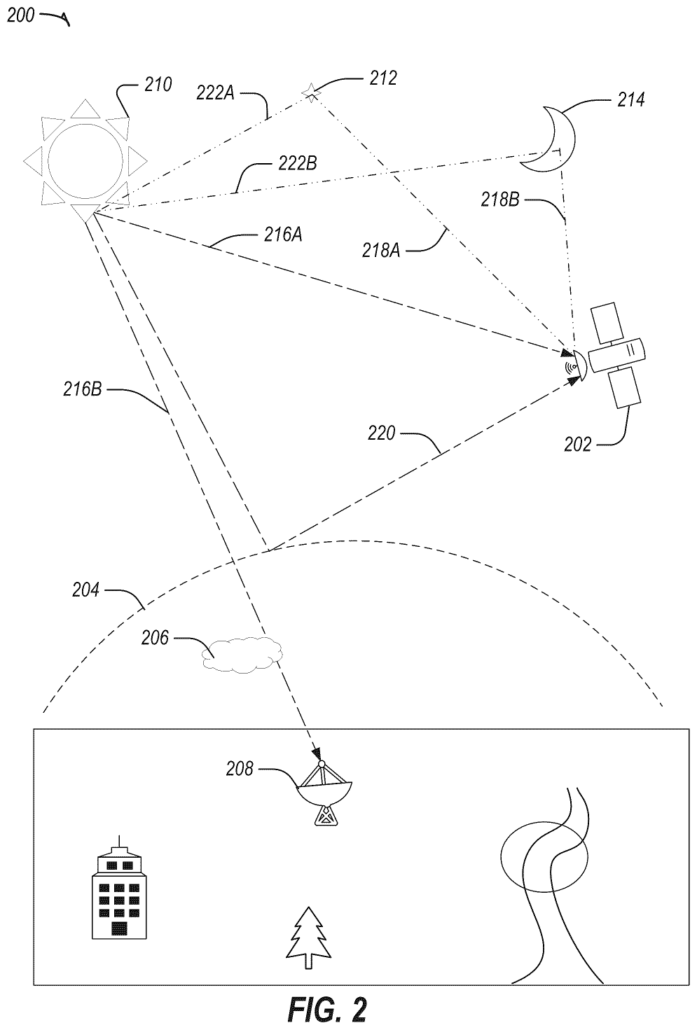

FIG. 2 illustrates a diagram showing a satellite 202 configured to generate a random number based on environmental data in accordance with some examples. The satellite 202 may rotate to have a field of view that includes a direct line of sight to the sun 210, a star 212, the moon 214, the atmosphere 204 of the earth, or the like, in any combination or alone. The satellite 202 may be orbiting the earth in a LEO. The satellite 202 may be the satellite 100 of FIG. 1 or include one or more components described with respect to satellite 100, in some examples.

The satellite 202 may capture a natural cosmic event and use the natural cosmic event as a source to generate a random number. The natural cosmic event may include capturing a gamma ray 216A (e.g., a burst) emitted by the sun 210 via a gamma ray detector on the satellite 202. The gamma ray detector may output information that may be converted to the random number. For example, the gamma ray detector may use characteristics of gamma ray burst such as a total duration of the gamma ray burst, a total energy captured by the gamma ray detector, etc. In an example, the satellite 202 may communicate with a ground station 208. The ground station may capture a gamma ray 216B (e.g., a burst) originating from the sun 210 at the same time as the gamma ray 216A. The ground station 208 may send information corresponding to the gamma ray 216B to the satellite 202 or the satellite 202 may send information corresponding to the gamma ray 216A to the ground station 208. The satellite 202, the ground station 208, or another device may determine a difference of time dilation between the gamma ray 216A and the gamma ray 216B to generate a random number. The ground station 208 may capture different information related to the gamma ray 216B (even if originating as the same gamma ray burst from the sun 210 as gamma ray 216A). For example, a cloud 206 or other object or weather phenomenon may partially obstruct or change the gamma ray 216B such that a gamma ray detector on at the ground station 208 has a different output than a gamma ray detector at the satellite 202 for the same gamma ray burst from the sun 210. An angle formed by the gamma rays 216A and 216B from the sun 210 may affect the output of a gamma ray detector on the satellite 202 or the ground station 208. The ground station 208 may be at a different distance to the sun 210 than the satellite 202, causing the ground station 208 (or in some cases, the satellite 202) to have a time delay or a time dilation for a gamma ray burst from the sun 210). Any of the above factors may be used in a comparison (e.g., by dividing one output by the other) to generate a decimal number that may be used as a random number.

In another example, by tracking a source of a gamma ray burst (e.g., a particular location on the sun 210), an angle that the satellite 202 is pitched at relative to a space based body may be used to generate a random number. For example, the satellite 202 and an originating portion of the sun 210 of the gamma ray 216A may be used as two vertices of a triangle, with the third vertex selected randomly (e.g., from a list of known and tracked natural satellites, artificial satellites, space debris, etc.). For example, the third vertex may include a star 212 or the moon 214. A triangle formed by the sun 210, the satellite 202, and the star 212 may include edges corresponding to the gamma ray 216A, a distance 218A to the star 212 from the satellite 202, and a distance 222A from the star 212 to the sun 210. Similarly, a triangle formed by the sun 210, the satellite 202, and the moon 214 may include edges corresponding to the gamma ray 216A, a distance 218B to the moon 214 from the satellite 202, and a distance 222B from the moon 214 to the sun 210. The total circumference of the triangle may be used as a random number. This triangle number is sufficiently random because the angle of the gamma ray 216A to the satellite 202 and the angle of the satellite to the randomly selected space based body are both random. In some examples, rather than, or in addition to, the total circumference, other aspects of the triangle may be sued to generate the random number, such as dividing one distance from another (e.g., 222A divided by 218A, etc.), dividing a ratio of two angles of the triangle, using an area of the triangle, or the like. In still other examples, more than one triangle may be used (e.g., by dividing an area or distance of a triangle having sides 216A, 218A and 222A by a triangle having sides 216A, 218B, and 222B). In an example, a distance between the gamma ray burst source on the sun 210 and the star 212, moon 214, or other celestial body may be divided by an angle of the satellite 202 to the gamma ray burst source on the sun 210 (e.g., with respect to a point on earth (e.g., the ground station 208), another celestial object, etc.), may be used to generate a random number. Although these examples are described with respect to a gamma ray burst, other cosmic phenomenon may be used. For example, light emitted by a comet at a particular moment may be captured by the satellite 202 for use as one of the edges of a triangle (e.g., with the comet being a vertex). In another example, light reflected from the moon 214 may be used (e.g., at a moment of moonrise with respect to the satellite 202). In an example, angular momentum of the satellite 202 may be used as a numerator or denominator for generating the random number (e.g., with any of the distances, areas, angles, etc. described above).

In an example, the satellite 202 may include a pyranometer to measure solar irradiance (e.g., originating at the sun 210). The solar irradiance may be used to determine a one time pad/password (OTP) or a random number. The solar irradiance is represented in FIG. 2 as lines 220, which show how the sun 210 emits light, which is reflected off of the atmosphere 204 of the Earth before being measured by the pyranometer at the satellite 202. The lines 220 are not necessarily shown in a correct orientation or angle, but are intended to be illustrative. The pyranometer may measuring a minute variation in Schumann resonance (SR) to output a value for generating a random number. The Schumann resonance or the solar irradiance may be measured during a specified time window to generate randomness. In some examples the ground station 208 may capture Schumann resonance or solar irradiance during the specified time window or a different time window. When different time windows are used, an offset in randomness may be determined based on the time differences. When the same specified time window is used at both the satellite 202 and the ground station 208, a same random number may be generated. The specified time window may be predetermined, such as before launching the satellite 202. When the same random number is generated at the satellite 202 and the ground station 208, a secure OTP may be generated (e.g., according to a specified algorithm, such as a predetermined known algorithm for generating a OTP based on a shared secret code) at both the satellite 202 and the ground station 208. The secure OTP may be used to encode and decode a message sent to or from the satellite 202 from or to the ground station 208. In some examples, a sequence of readings over time may be used to obtain a long random decimal, since spectrum peaks in a very low frequency portion of Earth's magnetic field, and fluctuates over time. Different oscillation frequencies may be used (e.g., up to eight from 8 Hz to 45 Hz). In some examples, any one or combination of a time interval, specific frequency, or resolution of the measurement may be used to generate the random number.

The solar irradiance reflected from the atmosphere 204 is shown as part of lines 220, originating at the sun 210. The sun 210 releases radiation having a number of photons. These photons hit the atmosphere 204, some are absorbed, some continue to the surface of the Earth, and some are reflected. The reflected photons may be measured to generate a random number. The reflected photons may be used to generate a random number based on a reflection coefficient of the atmosphere 204, a topographical state of terrain (e.g., causing diffusion or reflection), a difference of observation angle (e.g., 1 acres worth of reflected value results in a different number of reflected protons than 100 acres worth), or the like. Other aspects of the reflected solar irradiance that add to randomness include a parallax difference between the reflected point or area at the atmosphere 204 and the surface of the Earth (or cloud cover) as seen from the perspective of the satellite 202. The solar irradiance that is reflected back from the atmosphere 204 may be at a lower intensity or energy than what is emitted by the sun 210. For example, a highly charged particle emitted from the sun 210 may be reflected as lower intensity photons after passing through the atmosphere 204 and being reflected back to the satellite 202. In an example, a random number may be generated by performing fractional division between a high intensity photon (e.g., observed directly from the sun 210) and a reflective coefficient. Examples described herein have used a photon emission from the sun 210, and it will be appreciated that other emissions may be used, such as solar wind, gravitational waves, different frequencies (e.g., frequency of light such as visible, infrared, ultraviolet, x-ray, etc., which may be chosen randomly, in some examples), or the like.

The techniques for generating random numbers described herein may be used alone or in combination, such as by randomly choosing which sensor or random number to use, by combining one or more random number result (e.g., a result of the pyranometer and the triangle described above), or the like. Combinations may include summations, subtraction, division, multiplication, average, bitwise comparison, etc.

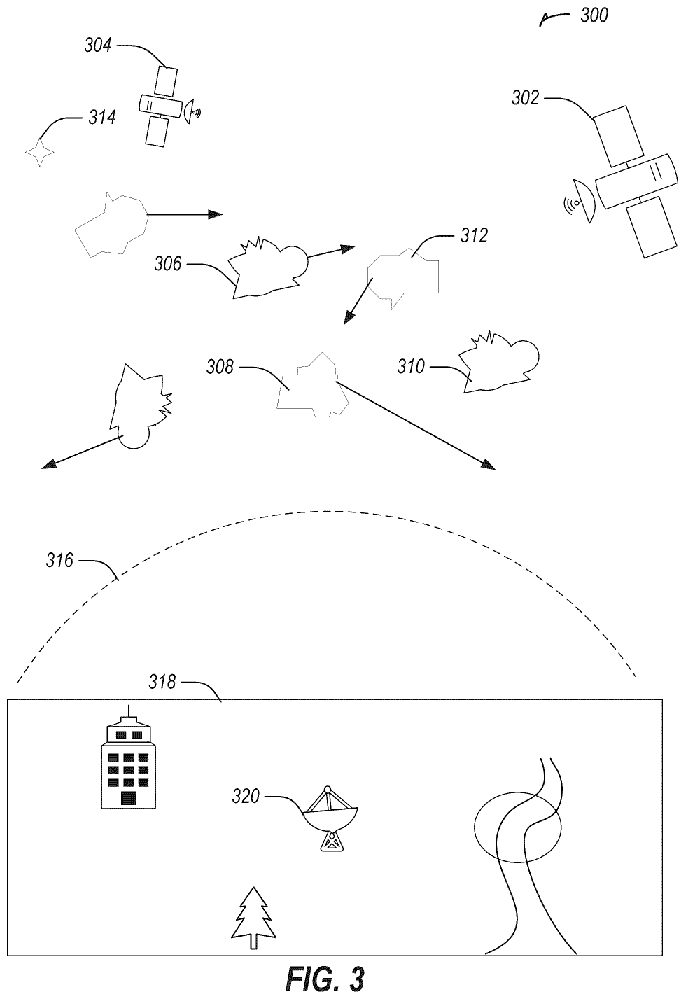

FIG. 3 illustrates a block diagram showing a satellite 302 configured to generate a random number based on space debris in accordance with some examples. The satellite 302 may rotate to have a field of view that includes a direct line of sight to a second satellite 304, a star 314, a debris field (e.g., including debris 306, 308, 310, 312), the atmosphere 316 of the earth 318, or the like, in any combination or alone. The satellite 302 may be orbiting the earth in a LEO. The satellite 302 may be the satellite 100 of FIG. 1 or include one or more components described with respect to satellite 100, in some examples.

The satellite 302 may use the debris field to generate a random number, such as by using a random distribution of the orbital space debris as source for entropy. For example, the satellite 302 may capture information of the debris 306, 308, 310, 312. The information may include an image, a reflection of pulsed light in a random pattern, radar (or other frequency) data, or the like. Further randomness may be generated using the backdrop of the Earth 318 (e.g., landmarks, cloud cover, atmospheric interference by the atmosphere 316, etc.), a location of the second satellite 304, a location of a celestial object such as the star 314, or the like, which may affect the captured data of the space debris 306, 308, 310, 312. The satellite 302 may include a radar or other frequency pulsed light, for example including an emitter and detector. In an example, the satellite 202 may capture information about the space debris 306, 308, 310, 312 in a snapshot of time over a particular angle and digitize the positions of the space debris 306, 308, 310, 312. This data may be captured in 2- or 3-dimensional space. The captured information may be used to calculate a vector over the data, and use the vector data to generate a random number. In an example, a ground station 320 may capture the debris 306, 308, 310, 312 to generate a random number. In this example, a random number generated at the satellite 202 may be used with the random number generated at the ground station 320 to generate a new random number (e.g., as discussed above, for example division, addition, etc.).

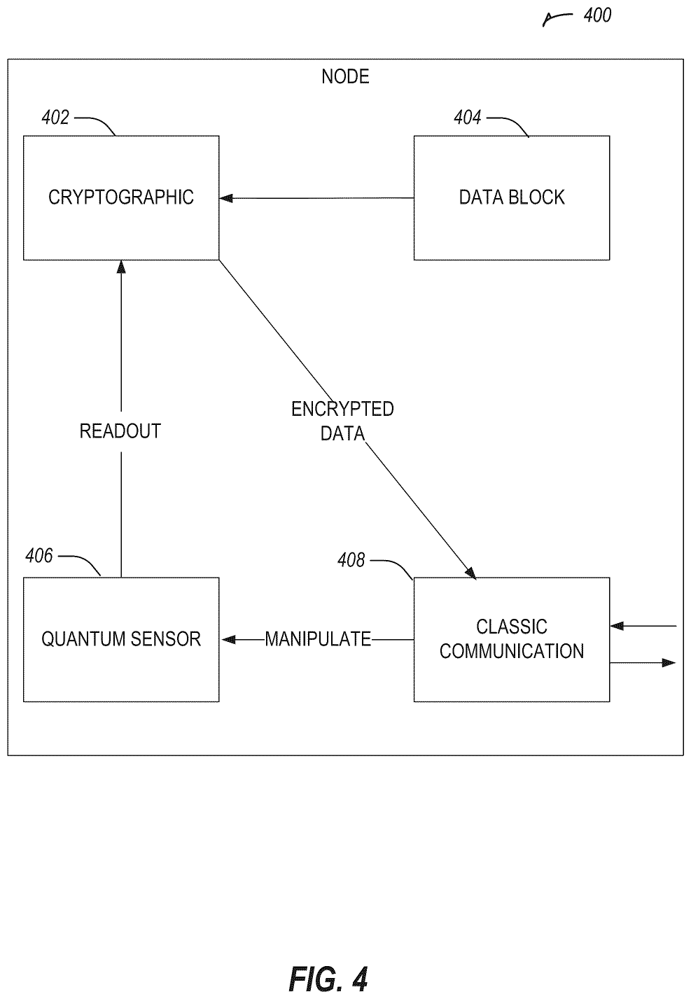

FIG. 4 illustrates example circuitry in a node 400 in accordance with some examples. The node 400 includes circuitry for communication, generation of cryptographic data, quantum data, etc., storage, and processing circuitry. The node 400 may be on a satellite, in some examples. The node 400 shown in FIG. 4 includes cryptographic circuitry 402, which may be used to generate, check, or deduce cryptographic key information. A data block 404 may be used to store cryptographic information, such as a list of one time pads or passwords, previously stored key information, a key generation algorithm, or the like. The node 400 includes classic communication circuitry 408 to communicate off of the node 400. The classic communication circuitry 408 may be used to send a received signal to a quantum sensor 406, which may interpret quantum data (e.g., a paired quantum bit. The quantum sensor 406 may send data related to the quantum data to the cryptographic circuitry 402 (e.g., a readout of entropy, a decimal value of a quantum bit, etc. The cryptographic circuitry 402 may use the data to generate or evaluate a key. A cryptographic key may be used to generate encrypted data (e.g., a message from the data block 404) to the classic communication circuitry 408, which may send the encrypted data to another node.

Each measurement of a quantum entangled particle may produce a random number using any suitable process to quantify the measurement into the random number. In some examples, a stream or multiple instances of a pair of entangled particles may be used to generate the random number with a desired bit length.

In an example, a random number generator of the node 400 (e.g., part of the cryptographic circuitry 402) may produce a random number based on measurements of a quantum derived seed comprising quantum entangled particles, wherein the node 400 measures a first particle in a pair of quantum entangled particles and wherein a second node measures a second particle in the pair of quantum entangled particles. In some examples, by using a pair of entangled particles, a measurement of the first particle at the node 400 may produce the same random number as a separate measurement of the second particle at the second node. This may provide a device for secure communication of random numbers to different nodes in the computing network.

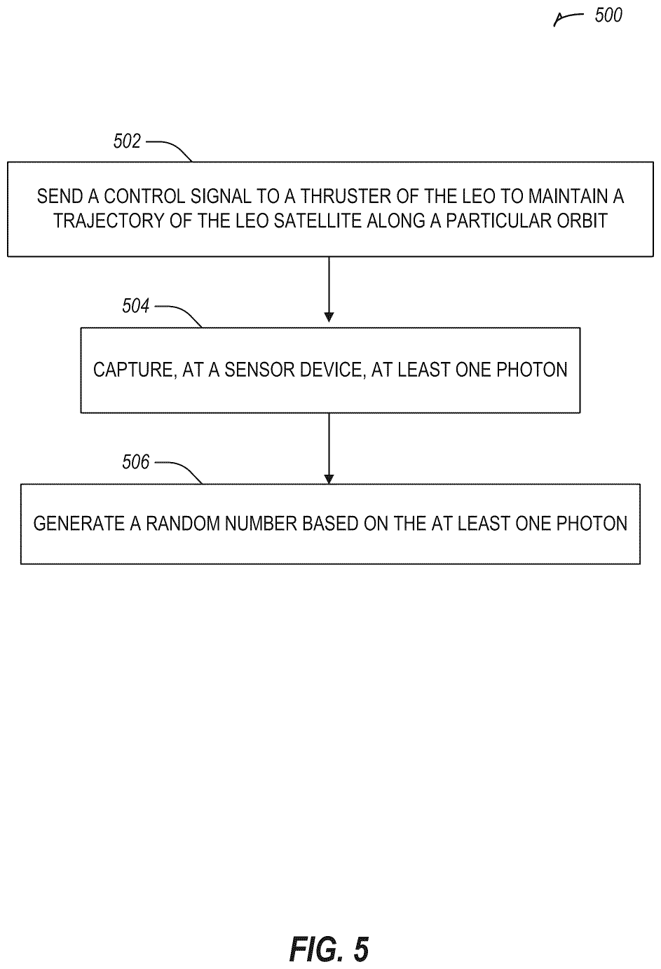

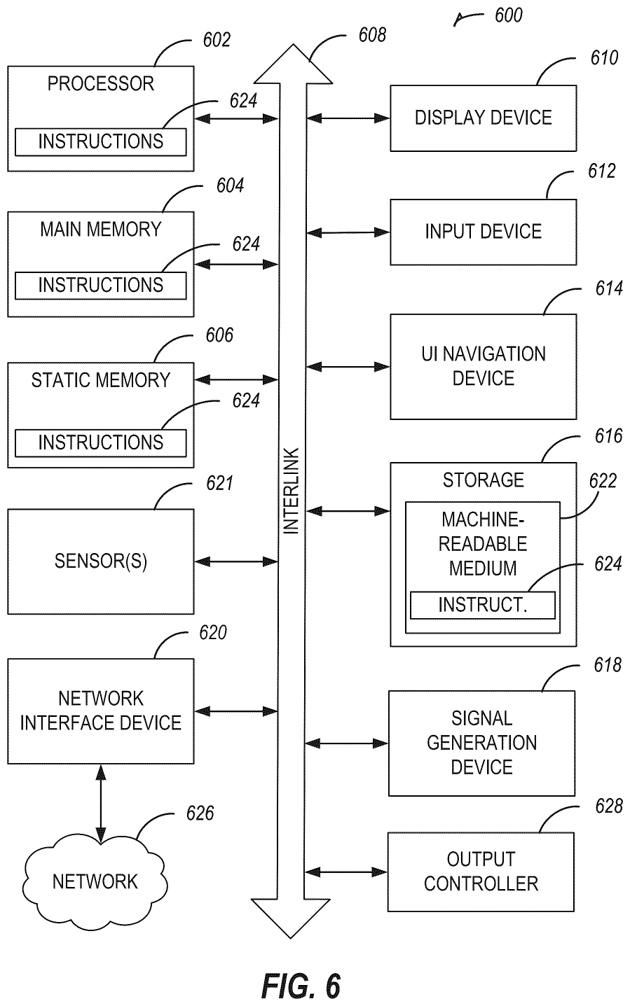

FIG. 5 illustrates a flowchart showing a technique 500 for controlling a low earth orbit (LEO) satellite in accordance with some examples. In an example, operations of the technique 500 may be performed by processing circuitry, for example by executing instructions stored in memory. The processing circuitry may include a processor, a system on a chip, or other circuitry (e.g., wiring), such as on a satellite (e.g., the LEO satellite). For example, technique 500 may be performed by processing circuitry of a device (or one or more hardware or software components thereof), such as those illustrated and described with reference to FIG. 1 or 6.

The technique 500 includes an operation 502 to send a control signal to a thruster of the LEO to maintain a trajectory of the LEO satellite along a particular orbit. The technique 500 includes an operation 504 to capture, at a sensor device, at least one photon.

The technique 500 includes an operation 506 to generate a random number based on the at least one photon. Operation 506 may include generating a plurality of random numbers, and performing a Monte Carlo simulation using the plurality of random numbers as seed values for the Monte Carlo simulation. In an example, the sensor device includes a gamma ray detector. In this example, the random number may be generated using an angle of sensor device to a source of the gamma ray energy photon, using an angle between a source of the gamma ray energy photon and an arbitrary heavenly body, using an angle between the LEO satellite and a ground station, or the like. Operation 506 may include using a hash value corresponding to an image capture of orbital space debris from an imaging device of the LEO satellite. In some examples, operation 506 includes using a solar irradiance measured by a pyranometer of the LEO satellite. In these examples, a solar radiation flux density measured by the pyranometer may be used to generate the random number. In these examples, the solar irradiance may include a solar irradiance reflected from a surface of the Earth.

The technique 500 may include generating a one-time passcode using the random number and sending the one-time passcode to a ground station or to a second satellite (e.g., via communication circuitry of the LEO satellite). The technique 500 may include generating a pair of cryptographic keys using the random number and sending a public key of the pair of cryptographic keys to a ground station or to a second satellite (e.g., via communication circuitry of the LEO satellite).

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a low earth orbit (LEO) satellite comprising: a thruster configured to maintain a trajectory of the LEO satellite along a particular orbit; a sensor device to capture at least one photon; processing circuitry; and memory, including instructions, which when executed by the processing circuitry, cause the processing circuitry to perform operations to: generate a random number based on the at least one photon.

In Example 2, the subject matter of Example 1 includes, wherein the instructions further cause the processing circuitry to perform operations to: generate a one-time passcode using the random number; and send the one-time passcode to a ground station or to a second satellite.

In Example 3, the subject matter of Examples 1-2 includes, wherein the instructions further cause the processing circuitry to perform operations to: generate a pair of cryptographic keys using the random number; and send a public key of the pair of cryptographic keys to a ground station or to a second satellite.

In Example 4, the subject matter of Examples 1-3 includes, wherein to generate the random number, the instructions further cause the processing circuitry to perform operations to generate a plurality of random numbers, and wherein the instructions further cause the processing circuitry to perform operations to perform a Monte Carlo simulation using the plurality of random numbers as seed values for the Monte Carlo simulation.

In Example 5, the subject matter of Examples 1-4 includes, wherein the sensor device is a gamma ray detector, and wherein the at least one photon includes a gamma ray energy photon.

In Example 6, the subject matter of Example 5 includes, wherein to generate the random number, the instructions further cause the processing circuitry to perform operations to use an angle of sensor device to a source of the gamma ray energy photon.

In Example 7, the subject matter of Examples 5-6 includes, wherein to generate the random number, the instructions further cause the processing circuitry to perform operations to use an angle between a source of the gamma ray energy photon and an arbitrary heavenly body.

In Example 8, the subject matter of Examples 5-7 includes, wherein to generate the random number, the instructions further cause the processing circuitry to perform operations to use an angle between the LEO satellite and a ground station.

In Example 9, the subject matter of Examples 1-8 includes, wherein to generate the random number, the instructions further cause the processing circuitry to perform operations to use a hash value corresponding to an image capture of orbital space debris from an imaging device of the LEO satellite.

In Example 10, the subject matter of Examples 1-9 includes, wherein to generate the random number, the instructions further cause the processing circuitry to perform operations to use a solar irradiance measured by a pyranometer of the LEO satellite.

In Example 11, the subject matter of Example 10 includes, wherein to use the solar irradiance includes to use a solar radiation flux density measured by the pyranometer.

In Example 12, the subject matter of Examples 10-11 includes, wherein to use the solar irradiance includes to use a solar irradiance reflected from a surface of the Earth.

Example 13 is a method for controlling a low earth orbit (LEO) satellite, the method comprising: sending a control signal to a thruster of the LEO to maintain a trajectory of the LEO satellite along a particular orbit; capturing, at a sensor device, at least one photon; and generating, using processing circuitry at the LEO satellite, a random number based on the at least one photon.

In Example 14, the subject matter of Example 13 includes, generating, using the processing circuitry, a one-time passcode using the random number; and sending, via communication circuitry, the one-time passcode to a ground station or to a second satellite.

In Example 15, the subject matter of Examples 13-14 includes, generating, using the processing circuitry, a pair of cryptographic keys using the random number; and sending, via communication circuitry, a public key of the pair of cryptographic keys to a ground station or to a second satellite.

In Example 16, the subject matter of Examples 13-15 includes, wherein generating the random number includes generating a plurality of random numbers, and further comprising performing, using the processing circuitry, a Monte Carlo simulation using the plurality of random numbers as seed values for the Monte Carlo simulation.

In Example 17, the subject matter of Examples 13-16 includes, wherein the sensor device is a gamma ray detector, and wherein the at least one photon includes a gamma ray energy photon.

In Example 18, the subject matter of Example 17 includes, wherein generating the random number includes using an angle of sensor device to a source of the gamma ray energy photon.

In Example 19, the subject matter of Examples 17-18 includes, wherein generating the random number includes using an angle between a source of the gamma ray energy photon and an arbitrary heavenly body.

In Example 20, the subject matter of Examples 17-19 includes, wherein generating the random number includes using an angle between the LEO satellite and a ground station.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A low earth orbit (LEO) satellite comprising:
a thruster configured to maintain a trajectory of the LEO satellite along a particular orbit;
a sensor device to capture at least one photon;
processing circuitry; and
memory, including instructions, which when executed by the processing circuitry, cause the processing circuitry to perform operations to:
generate a random number based on the at least one photon.

2. The LEO satellite of claim 1, wherein the instructions further cause the processing circuitry to perform operations to:
generate a one-time passcode using the random number; and
send the one-time passcode to a ground station or to a second satellite.

3. The LEO satellite of claim 1, wherein the instructions further cause the processing circuitry to perform operations to:
generate a pair of cryptographic keys using the random number; and
send a public key of the pair of cryptographic keys to a ground station or to a second satellite.

4. The LEO satellite of claim 1, wherein to generate the random number, the instructions further cause the processing circuitry to perform operations to generate a plurality of random numbers, and wherein the instructions further cause the processing circuitry to perform operations to perform a Monte Carlo simulation using the plurality of random numbers as seed values for the Monte Carlo simulation.

5. The LEO satellite of claim 1, wherein the sensor device is a gamma ray detector, and wherein the at least one photon includes a gamma ray energy photon.

6. The LEO satellite of claim 5, wherein to generate the random number, the instructions further cause the processing circuitry to perform operations to use an angle of sensor device to a source of the gamma ray energy photon.

7. The LEO satellite of claim 5, wherein to generate the random number, the instructions further cause the processing circuitry to perform operations to use an angle between a source of the gamma ray energy photon and an arbitrary heavenly body.

8. The LEO satellite of claim 5, wherein to generate the random number, the instructions further cause the processing circuitry to perform operations to use an angle between the LEO satellite and a ground station.

9. The LEO satellite of claim 1, wherein to generate the random number, the instructions further cause the processing circuitry to perform operations to use a hash value corresponding to an image capture of orbital space debris from an imaging device of the LEO satellite.

10. The LEO satellite of claim 1, wherein to generate the random number, the instructions further cause the processing circuitry to perform operations to use a solar irradiance measured by a pyranometer of the LEO satellite.

11. The LEO satellite of claim 10, wherein to use the solar irradiance includes to use a solar radiation flux density measured by the pyranometer.

12. The LEO satellite of claim 10, wherein to use the solar irradiance includes to use a solar irradiance reflected from a surface of the Earth.

13. A method for controlling a low earth orbit (LEO) satellite, the method comprising:
sending a control signal to a thruster of the LEO to maintain a trajectory of the LEO satellite along a particular orbit;
capturing, at a sensor device, at least one photon; and
generating, using processing circuitry at the LEO satellite, a random number based on the at least one photon.

14. The method of claim 13, further comprising:
generating, using the processing circuitry, a one-time passcode using the random number; and
sending, via communication circuitry, the one-time passcode to a ground station or to a second satellite.

15. The method of claim 13, further comprising:
generating, using the processing circuitry, a pair of cryptographic keys using the random number; and
sending, via communication circuitry, a public key of the pair of cryptographic keys to a ground station or to a second satellite.

16. The method of claim 13, wherein generating the random number includes generating a plurality of random numbers, and further comprising performing, using the processing circuitry, a Monte Carlo simulation using the plurality of random numbers as seed values for the Monte Carlo simulation.

17. The method of claim 13, wherein the sensor device is a gamma ray detector, and wherein the at least one photon includes a gamma ray energy photon.

18. The method of claim 17, wherein generating the random number includes using an angle of sensor device to a source of the gamma ray energy photon.

19. The method of claim 17, wherein generating the random number includes using an angle between a source of the gamma ray energy photon and an arbitrary heavenly body.

20. The method of claim 17, wherein generating the random number includes using an angle between the LEO satellite and a ground station.
